(19) United States
(12) Patent Application Publication
(10) Pub. No.: US 2012/0252439 A1
(43) Pub. Date: Oct. 4, 2012

(54) SYSTEM AND METHOD FOR ESTIMATING CASUALTIES

(75) Inventors: Robert W. Peterson, Plano, TX (US); Deren George Ebdon, Carrollton, TX (US)

(73) Assignee: Recursion Software, Inc., Frisco, TX (US)

(21) Appl. No.: 13/078,937

(22) Filed: Apr. 2, 2011

(51) Int. Cl. H04W 24/10

(52) U.S. Cl. 455/423

(57) ABSTRACT

To estimate the number of casualties at an event, a query may be sent to mobile device history database(s) associated with one or more mobile base stations that provide service coverage to an area that encompasses the event. The query determines the number of abnormal disconnects from the base station in a time interval immediately after the event. From the query response, a calculation may be performed of the number of casualties, with some or all of these abnormal disconnects being considered to indicate a casualty. Additional parameters can be applied to a casualty calculation, such as the percentage of persons in an area who would normally carry a mobile device that is connected to the one or more base stations.

### FIELD OF THE INVENTION

This disclosure relates to systems and methods for estimating the number of casualties at an event.

### BACKGROUND OF THE INVENTION

Coordinating an event response can be made more efficient if the number of casualties can be reliably estimated. Quickly estimating the number of casualties caused by an event that causes a large number of injuries or deaths currently relies on subjective personal observations. The estimators rarely know with any accuracy of the number of individuals in the area of the event. Current solutions require interviewing survivors, witnesses, individuals familiar with the normal population of the area involved in the event, first responder observations of the event aftermath, and/or examination of passenger manifests relevant to the event.

All of the current approaches require significant time, and the time required can delay allocation of emergency and recovery resources. The error in the resulting estimates can result in inadequate or excess allocation of first responder and recovery resources.

What is required is an improved system and method for estimating casualty rates after an event.

### SUMMARY OF THE INVENTION

To estimate the number of casualties at an event, a query may be sent to mobile device history database(s) associated with one or more mobile base stations that provide service coverage to an area that encompasses the event. The query determines the number of abnormal disconnects from the base station in a time interval immediately after the event. From the query response, a calculation may be performed of the number of casualties, with some or all of these abnormal disconnects being considered to indicate a casualty. Additional parameters can be applied to a casualty calculation, such as the percentage of persons in an area who would normally carry a mobile device that is connected to the one or more base stations

In one aspect of the disclosure, there is provided a method for estimating the number of casualties after an event. The number of mobile devices abnormally disconnected from at least one mobile network in a coverage area that encompasses an area of the event in a time interval after a time of the event may be determined. This number may then be used in performing a calculation of an estimate of the number of casualties of the event.

In one aspect of the disclosure, there is provided a system for estimating the number of casualties of an event comprising at least one casualty estimate processor programmed to perform a calculation of a casualty rate. The at least one processor may be programmed to provide a query to at least one mobile network that queries the number of abnormal disconnects from the mobile network in a network coverage area that includes an event area, receive a query response that indicates the number of abnormal disconnects from the mobile network, and calculate the casualty rate using the number of abnormal disconnects from the at least one mobile network.

In one aspect of the disclosure, there is provided a computer-readable medium comprising computer-executable instructions for execution by at least one processor, that, when executed, cause the at least one processor to provide a query to at least base station of at least one mobile network that queries the number of abnormal disconnects of mobile devices from the at least one base station, receive a query response that indicates the number of abnormal disconnects from the at least one base station, and calculate the casualty rate of an event that occurred in a coverage area of the at least one base station using the number of abnormal disconnects from the at least one base station.

### BRIEF DESCRIPTION OF THE DRAWINGS

Reference will now be made, by way of example only, to specific embodiments and to the accompanying drawings in which:

FIG. 1 shows a system for performing a casualty estimate calculation; and

FIG. 2 shows a method for calculating on estimate of casualties.

### DETAILED DESCRIPTION OF THE INVENTION

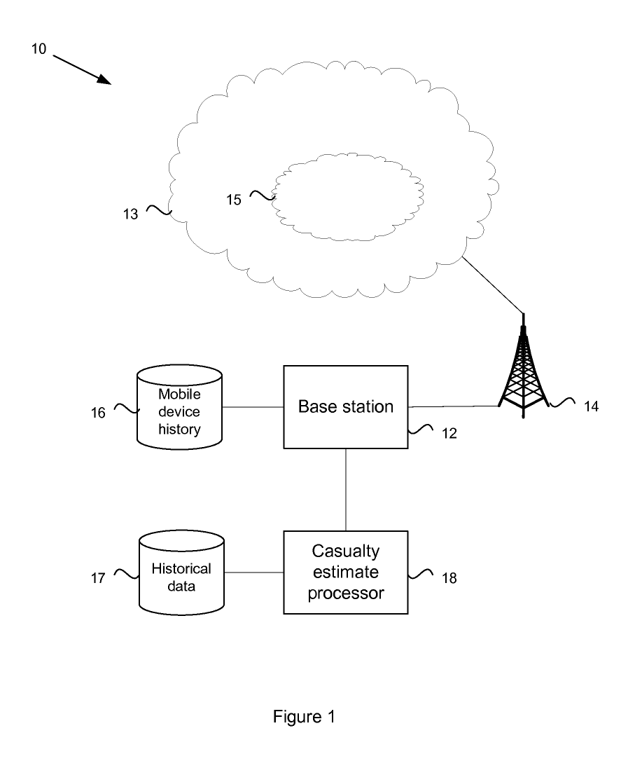

In FIG. 1, there is shown a system 10 that can be used as a basis for estimating casualty rates after an event. The system 10 includes one or more mobile base stations 12 that that provide network coverage to a cell tower coverage area 13 via one or more cell towers 14, as is known. For the present purposes, an event is assumed to have occurred within an event area 15 that is within the cell tower coverage area. While a single cell tower 14 is shown and the event area is shown as being within the coverage area of a single cell tower, a person skilled in the art will readily understand that the event area may overlap several cell tower coverage areas 13.

The base station 12 and cell tower 14 provide network coverage to mobile devices (e.g., cell phones, tablet and mobile computers, etc.) that are within the cell coverage area 13 as is known. Whenever a mobile device switches on, it registers with the nearest base station in order that calls and communications to the mobile device can be connected. Message protocols are implemented by mobile devices and base stations that implement a message a mobile device uses to notify a base station of a normal disconnect, such as when a mobile device is naturally switched off by the user. An example of such a message is GSM's IMSI attach and IMSI detach messages, where “IMSI” is International Mobile Subscriber Identity. Other similar protocols may be used. The message protocols implemented by mobile devices and base stations may also implement periodic messages from a mobile device to a base station that the base station can use to automatically disconnect a device that abruptly stops communicating.

The cellular network implementation expects a mobile device to notify the network when the device disconnects, e.g., at power down time, when switching to “airplane mode”, etc. In some cases a device either cannot send the disconnect message, such as when a user abruptly removes a device's power source, the device abruptly loses radio communication with the base station due to environmental factors, or the disconnect message, which in some protocols is sent only once and is not acknowledged, is damaged such that the base station cannot properly receive or process it. A mobile device and base station typically implement a protocol feature in which base station directs the device to periodically send a message to the base station, frequently to update the device's location. When a base station fails to receive a message from the mobile device after protocol-specified time, the base station assumes the device is no longer functioning and executes the disconnect procedure just as if the device had sent the disconnect message.

A mobile device history database 16 may be associated with a base station and used to log a history of mobile device disconnects, including natural and forced disconnects.

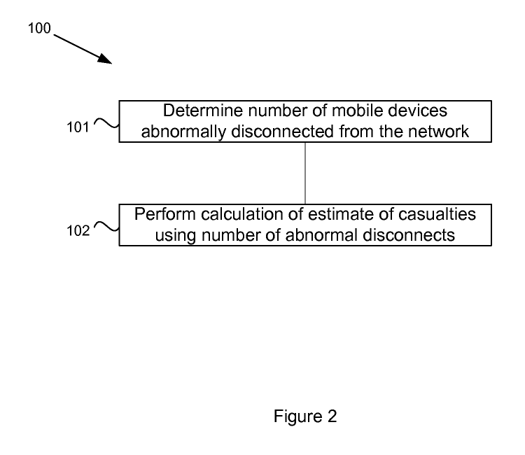

The system 10 may include a casualty estimate processor 18 that is programmed to calculate an estimate of casualties in response to an event. The calculation may use historical data retrieved from a historical database 17 operatively associated with the casualty estimate processor 18. A process for calculating an estimate of casualties for an event is depicted in the flowchart 100 of FIG. 2. At step 101, the casualty estimate processor 18 determines the number of mobile devices abnormally disconnected from the mobile network in a time interval at a time of the event and estimates the number of casualties from the number of mobile devices abnormally disconnected during the time interval (step 102).

The casualty estimate processor 18 may perform the casualty estimate using a combination of historical data, real-time data and input parameters. The casualty estimate calculation may be triggered by a user input which includes an input of the time of the event. Alternatively, the time interval may be a configurable parameter provided with a default value, e.g., five minutes. In an alternative embodiment, the casualty estimate calculation may be triggered in response to detecting an enhanced rate of abnormal disconnects from the network. This triggering may automatically provide the time of the event.

The casualty estimate processor may be connected to the mobile device history database 16, either directly or via the base station 12. The processor 18 may provide the time of the event in a query to the mobile device history database to retrieve the number of devices connected to the mobile network immediately prior to the event time and the number of devices abnormally disconnected in a time interval immediately following the event. The mobile device history database 16 returns in a query response the number of devices connected to the mobile network immediately prior to the event time and the number of devices abnormally disconnected in a time interval immediately following the event. For example, 4 abnormal disconnects might be significant if the number of devices was 10, but insignificant and normal if the number of devices was 10,000.

The number of abnormal disconnects represents the number of mobile devices disconnected from the base station for reasons other than the normal disconnect message, e.g., because of a timeout caused by devices' failure to send expected messages. Knowing the number of devices connected prior to the event is not essential, but aids in determining whether the number of abnormal disconnects is significant.

Once the number of abnormal disconnects for the coverage area has been determined, an assumption is then made as to the fraction of mobile devices forcibly disconnected due to the event. The assumption assumes that the same percentage of device owners became casualties. Alternatively, an additional assumption parameter may be provided that represents the fraction of mobile device owners of forcibly disconnected devices who became casualties.

In one embodiment, the processor 18 uses a fixed and configurable assumption parameter to estimate the number of forced disconnects due to the event. For example, a configurable parameter of 95% of forced disconnects may be attributed to the event. The 95% value may be provided as a default value for the calculation but may be amended by a user guiding the calculation if appropriate.

The processor 18 multiplies the number of abnormal disconnects in the time interval following the event by the assumption factor to estimate the number of casualties.

In an alternative embodiment, the mobile device history database 16 and/or the historical database 17 may provide a historical rate of abnormal disconnects under normal circumstances. This historical rate may be compared to the abnormal disconnect rate retrieved for the time interval following the event to determine an enhanced abnormal disconnect rate. The absolute number of abnormal disconnects returned by the query to the mobile device history database 16 may be multiplied by the enhanced abnormal disconnect rate to calculate the casualty rate.

In one embodiment, the casualty estimate processor 18 may apply a usage factor to the casualty estimate. The usage factor may represent the percentage of individuals in the area of the event who would normally carry a mobile device that is connected to a base station. The casualty estimate processor 18 may retrieve a usage factor from the history database 17. The usage parameter may be provided as a global population figure or may be provided on an area by area basis. The usage parameter may also be time of day dependent since, for example, a greater number of devices may be in use during the day in an area than at night. The usage parameter may be a historical figure or may be input at the time of an event. The casualty estimate processor 18 multiples the casualty rate estimated from the number of abnormal disconnects by the usage factor to arrive at a more complete estimate of the casualty rate.

The casualty estimate process may be repeated for each network provider that provides coverage to the event area. Alternatively, a single computation may be made by receiving historical data and mobile device history from multiple service providers into a single casualty estimate processor. In a further alternative, historical market share parameters may be used so that a casualty calculation for one mobile network provider may be extrapolated to a calculation for all service providers to an event area.

Accurate casualty estimates enable efficient allocation of response resources, including first responder personnel, emergency transport, event mitigation equipment (fire suppression, toxic spill containment, etc.), trauma treatment facilities, morgue facilities, etc. In particular, early identification of large numbers of casualties will reduce the number of deaths and the recovery time of injured individuals by reducing response time and improving medical care during the initial response.

The casualty estimate calculation can be applied and the result known as soon as emergency response centers learn of an event potentially involving a significant number of casualties. This would typically happen before first responders arriving on the scene have time to produce an estimate. Events that might be suitable for the casualty estimate calculation include, without limitation, wrecks involving mass transit (intercity passenger trains, urban light rail, subways, busses), spills of toxic chemicals, tsunamis, hurricanes, tornados, and fires in large structures such as vehicle tunnels, office buildings or schools.

Although embodiments of the present invention have been illustrated in the accompanied drawings and described in the foregoing description, it will be understood that the invention is not limited to the embodiments disclosed, but is capable of numerous rearrangements, modifications, and substitutions without departing from the spirit of the invention as set forth and defined by the following claims. For example, the capabilities of the invention can be performed fully and/or partially by one or more of the blocks, modules, processors or memories. Also, these capabilities may be performed in the current manner or in a distributed manner and on, or via, any device able to provide and/or receive information. Further, although depicted in a particular manner, various modules or blocks may be repositioned without departing from the scope of the current invention. Still further, although depicted in a particular manner, a greater or lesser number of modules and connections can be utilized with the present invention in order to accomplish the present invention, to provide additional known features to the present invention, and/or to make the present invention more efficient. Also, the information sent between various modules can be sent between the modules via at least one of a data network, the Internet, an Internet Protocol network, a wireless source, and a wired source and via plurality of protocols.

1. A method for estimating the number of casualties after an event comprising:
determining a number of mobile devices abnormally disconnected from at least one mobile network in a coverage area that encompasses an area of the event in a time interval after a time of the event;
retrieving a usage parameter that represents a percentage of individuals in an area who would normally carry a mobile device that is connected to the at least one mobile network; and
performing a calculation in at least one specifically programmed processor to calculate an estimate of the number of casualties from the number of mobile devices abnormally disconnected during the time interval and the usage parameter.

2. (canceled)

3. The method of claim 1 comprising retrieving the usage parameter from a database.

4. The method of claim 1 comprising determining the number of mobile devices connected to the at least one mobile network at a time immediately prior to the event.

5. The method of claim 1 comprising performing the step of determining the number of mobile devices abnormally disconnected from the at least one mobile network for a plurality of mobile networks that provide mobile service to the area of the event.

6. The method of claim 1 comprising:
retrieving a historical rate of abnormal disconnects;
determining an enhanced rate of abnormal disconnects relative to the historical rate of abnormal disconnects; and
estimating the number of casualties from the enhanced rate of abnormal disconnects.

7. The method of claim 1 wherein determining the number of mobile devices abnormally disconnected from the mobile network comprises providing a query to a mobile device history database and receiving a query response that indicates the number of mobile devices abnormally disconnected from the mobile network.

8. The method of claim 7 comprising indicating the time of the event in the query.

9. A system for estimating the number of casualties of an event comprising at least one casualty estimate processor programmed to perform a calculation of a casualty rate; wherein the at least one processor is configured to:
provide a query to at least one mobile network that queries the number of abnormal disconnects from the mobile network in a network coverage area that includes an event area;
receive a query response that indicates the number of abnormal disconnects from the mobile network; and
calculate the casualty rate using the number of abnormal disconnects from the at least one mobile network and a usage factor that represents a percentage of individuals in an area who would normally carry a mobile device that is connected to the at least one mobile network.

10. The system of claim 9 comprising at least one history database that stores one or more parameters for the calculation of the casualty rate, wherein the at least one processor is configured to calculate the casualty rate using one or more parameters from the at least one history database.

11. (canceled)

12. The system of claim 10 wherein the one or more parameters comprise a time interval and wherein the query provided to the at least one mobile network comprises a time of the event and the time interval.

13. The system of claim 9 wherein the processor is configured to provide the query to a plurality of mobile networks that provide mobile service to the event area.

14. The system of claim 9 wherein the processor is configured to query the at least one mobile network to determine the number of mobile devices connected to the at least one mobile network at a time immediately prior to the event

15. A non-transitory computer-readable medium comprising computer-executable instructions for execution by at least one processor, that, when executed, cause the at least one processor to:
provide a query to at least base station of at least one mobile network that queries the number of abnormal disconnects of mobile devices from the at least one base station;
receive a query response that indicates the number of abnormal disconnects from the at least one base station; and
calculate the casualty rate of an event that occurred in a coverage area of the at least one base station using the number of abnormal disconnects from the at least one base station and a usage parameter that represents a percentage of individuals in an area covered by the at least one base station who would normally carry a mobile device that is connected to the at least one base station.

16. The non-transitory computer-readable medium of claim 15 comprising computer-executable instructions that, when executed, cause the processor to:
determine a time of the event;
determine a time interval;
provide the time of the event and the time interval in the query to the at least one base station;
wherein the query response indicates the number of abnormal disconnects from the at least one base station during the time interval after the time of the event.

17. The non-transitory computer-readable medium of claim 16 comprising computer-executable instructions that, when executed, cause the processor to provide a query to the at least one base station to determine the number of mobile devices connected to the at least one base station at a time immediately prior to the time of the event.

18. (canceled)

19. The non-transitory computer-readable medium of claim 15 comprising computer-executable instructions that, when executed, cause the processor to retrieve the usage parameter from a database.

20. The non-transitory computer-readable medium of claim 15 comprising computer-executable instructions that, when executed, cause the processor to calculate the casualty rate for a plurality base stations of a plurality of mobile networks.
